(19) United States
(12) Patent Application Publication
(10) Pub. No.: US 2014/0315104 A1
(43) Pub. Date: Oct. 23, 2014

(54) Lithium Battery Electrodes Containing Lithium Oxalate

(71) Applicant: DOW GLOBAL TECHNOLOGIES LLC, Midland, MI (US)

(72) Inventors: Wenjuan Liu, Midland, MI (US); Murali G. Theivanayagam, Midland, MI (US); Koichi Numata, Midland, MI (US); Ing-Feng Hu, Midland, MI (US); David R. Wilson, Midland, MI (US); Yiyong He, Midland, MI (US)

(21) Appl. No.: 14/356,728

(22) PCT Filed: Nov. 30, 2012
(86) PCT No.: PCT/US12/67315

§ 371 Date: May 7, 2014

Related U.S. Application Data
(60) Provisional application No. 61/570,777, filed on Dec. 14, 2011.

(51) Int. Cl. H01M 4/36

(52) U.S. Cl. CPC H01M 4/364
USPC 429/331; 429/342; 429/338; 429/326; 429/332

(57) ABSTRACT

Cathodes for lithium batteries contain a lithium-manganese cathodic material and from 0.5 to 20% by weight of lithium oxalate. Batteries containing the electrodes tend to exhibit high cycling capacities.

Lithium batteries form a fast-growing segment of the battery market. They are of great interest in many applications, including hybrid vehicles and plug-in hybrid vehicles. These batteries are often manufactured with a lithium-transition metal oxide or a lithium-transition metal phosphate cathode and a graphite electrode.

Lithium manganese oxide or lithium manganese phosphate cathodic materials potentially can provide for high voltages (in excess of 4.1 volts) against lithium. These high voltages in principle allow high specific energies to be obtained, which is very desirable, especially in electric and hybrid vehicle applications where weight is a major concern.

Applications such as electric and hybrid vehicles require the battery to operate at high charge/discharge rates, in which energy is supplied to or discharged from the battery at high rates. Battery charge/discharge rates are sometimes expressed as a “C-rate”, with a 1C charge or discharge rate referring to a rate of charge or discharge at a rate that would result in the complete charge to or discharge from the battery's nominal capacity in one hour. Higher “C-rates” indicate faster charge/discharges; hence a C-rate of 2C indicates a charge or discharge rate twice that of a 1C rate, and a C-rate of 1/2C indicates a charge or discharge rate one-half that a 1C rate.

Most consumer electronic devices operate at C-rates of C/20 to C/2. Operation at lower C-rates are in general less demanding and battery performance is usually better at lower C-rates. Electric and hybrid vehicle batteries, on the other hand, often are called upon to discharge at rates of 1C or greater, at least periodically during acceleration and hill-climbing, and to at least periodically charge at similarly high rates. Operation at high C-rates leads to at least four problems. First, the actual capacity that a battery can deliver is lower at high C-rates than at lower C-rates. The second problem is that battery lifetimes suffer very significantly when operated at high C-rates. The capacity of the battery diminishes significantly as the battery is put through charge/discharge cycles at high C-rates. The third problem is the batteries are sensitive to temperature, and lose capacity very rapidly when operated at even moderately elevated temperatures, such as up to 50° C. The fourth problem is that the batteries exhibit unacceptably short lifetimes when operated at charge voltages greater than 4.2V. Higher charge voltages, up to 4.5 V or more, are sometimes desired because of the correspondingly high specific energies that can be obtained.

The lifetime problem in batteries that have lithium manganese oxide or lithium manganese phosphate electrodes is partially attributable to the dissolution of manganese from the electrode into the electrolyte. The dissolved manganese can deposit onto the anode during cell cycling.

Manganese dissolution, in turn, is at least partially related to the decomposition of LiPF₆, which is the electrolyte salt of choice in most lithium batteries. LiPF₆ can decompose to form PF₅ which can react with water or alcohols to generate hydrogen fluoride (HF). HF can dissolve manganese into the electrolyte solution, and may also contribute to manganese dissolution by degrading cathode protection materials such as a passivation layer, thereby exposing more of the manganese to the electrolyte solution.

Therefore, many attempts to improve battery life and performance have focused on eliminating HF, either by preventing HF from forming or by scavenging HF as it forms.

Because water and alcohols can contribute to HF formation, one approach is to scrupulously eliminate these materials from the electrolyte solution, typically by carefully drying the electrolyte solution and/or its components. However, it is very difficult to remove these materials to the very low levels that are needed, and doing so increases expense. Moreover, this approach has not satisfactorily solved the problem of manganese dissolution.

Another approach is to replace LiPF₆ with another, more stable lithium salt such as LiBF₄, LiB(C₂O₄)₂ (LiBOB), LiBF₂C₂O₄ or LiPF₄C₂O₄. Electrolytes containing these salts suffer from various drawbacks, including lower conductivity in some cases and poor low temperature performance in other cases. As a result, these alternative salts are generally inadequate substitutes for LiPF₆.

Still another approach is to include some additive in the electrolyte solution, which stabilizes the electrolyte salt or PF₅, and/or scavenges HF. LiF in small amounts can suppress LiPF₆ decomposition. Various weak Lewis bases can stabilize PF₅ by forming a weak complex thereto; among these Lewis basis are various fluorinated phosphoric esters such as tris(2,2,2-trifluoroethyl)phosphite, various amides, 1-methyl-2-pyrrolidinone, fluorinated carbamates, hexamethyl phosphoramide, various compounds containing Si—H bonds and various Si—N compounds. Additives such as these are described, for example, in S. S. Zhang, Journal of Power Sources 162 (2006) 1379-1394, JP 2011-044245, JP 2001-167792 and JP 2010-086681. These additives increase the cost and complexity of the electrolyte formulation, and often are insufficiently effective.

Lithium oxalate (Li₂C₂O₄) is known to react with two moles of PF₅ to produce LiPF₄C₂O₄ and LiPF₆, and so is potentially a candidate for use as a stabilizer. However, lithium oxalate is only poorly soluble in the carbonate compounds that are overwhelmingly the solvents of choice for lithium battery electrolyte solutions. This limits the effectiveness of lithium oxalate as an additive into the battery electrolyte solution.

It would be desirable to provide a lithium battery having a cathode containing a lithium manganese compound, which battery retains a large proportion of its capacity after undergoing multiple charge/discharge cycles, especially at C-rates of 1C or higher. Such a battery preferably has a wide temperature operating window, and preferably retains its capacity well when operated at charge voltages of as much as 4.5V or more.

In one aspect, this invention is a cathode for a lithium battery comprising particles of at least one lithium-manganese cathodic material bound together by a binder and which further contains from 0.5 to 20 parts by weight of lithium oxalate per 100 parts by weight of the particles of lithium-manganese cathodic material.

This invention is also a method for making a cathode for a lithium battery, comprising the steps of (A) forming a slurry containing (1) particles of at least one lithium-manganese cathodic material, (2) from 0.5 to 20 parts by weight of lithium oxalate per 100 parts by weight of the particles of lithium-manganese cathodic material, (3) at least one binder and (4) at least one diluent and (B) drying the slurry to remove the diluent and form a cathode in which the lithium-manganese particles are bound together by the binder and which contains the lithium oxalate.

The invention is also a lithium battery comprising the cathode of the invention, an anode, a separator disposed between the anode and cathode, and an electrolyte solution in contact with the anode and cathode.

Very surprisingly, the inclusion of the lithium oxalate into the cathode leads to very significant improvements in the performance of the lithium battery. These improvements outstrip those seen when lithium oxalate is included as an additive in the electrolyte solution, particularly when the solvent is a mixture of carbonates as is now generally favored in the industry. Initial specific charge and discharge capacities can be 5%-20% or more larger than that of a similar battery without lithium oxalate present in the cathode. The loss of specific capacity is also significantly slower for the battery of this invention, compared to a like battery without lithium oxalate present in the cathode. By contrast, lithium oxalate in the electrolyte solution provides little benefit, at least in the common carbonate solvent-based electrolyte solutions favored by industry. These advantages are even more pronounced at high C rates and at somewhat elevated temperatures.

The lithium-manganese cathodic material is a compound or mixture of compounds that contain lithium and manganese, and which reversibly intercalate (insert) lithium ions during a battery discharge cycle and release (extract or deintercalate) lithium ions into a battery electrolyte solution during a battery charging cycle. Examples of such lithium-manganese cathodic materials include, for example, lithium-manganese oxides, lithium-manganese phosphates, lithium-manganese silicates, lithium-manganese sulfates, lithium-manganese borates, lithium-manganese vanadates and the like. In any of the foregoing cases, the lithium-manganese cathodic material may contain other metals, such as Fe, Co, Ni, Cr, V, Mg, Ca, Al, B, Zn, Cu, Nb, Ti, Zr, La, Ce, Y or a mixture of any two or more thereof. Such other metals are typically present, if at all, in a mole ratio with manganese of from 1:9 to 9:1.

Some suitable lithium-manganese cathodic materials include manganese-containing olivine cathodic materials. These include olivine lithium-manganese phosphates that have the empirical formula LiₐMnₓM₍₁₋ₓ₎(PO₄)_{b}, wherein x is from 0.1 to 1.0, M is Fe, Co, Ni, Cr, V, Mg, Ca, Al, B, Zn, Cu, Nb, Ti, Zr, La, Ce, Y or a mixture of any two or more thereof, a is from 0.8 to 1.3, preferably from 0.8 to 1.1 and b is from 0.9 to 1.3. M is preferably Fe, Co, Ni or a mixture of any two or more thereof. x is preferably from 0.25 to 1, more preferably from 0.25 to 0.9, and still more preferably from 0.5 to 0.9. Especially preferred cathodic materials of this type include olivine LiₐMn_{0.25-0.9}Fe_{(0.75-0.1)}(PO₄)_{b} where a and b are as defined before.

Other suitable lithium-manganese cathodic materials include manganese-containing spinel materials. These include lithium-manganese oxides that have the empirical formula LiₐMn_{z}M_{(2-z)}O₄, wherein z is from 0.25 to 2.0 and M and a are as before. M is preferably Fe, Co, Ni or a mixture of any two or more thereof, and is most preferably Ni. Z is preferably from 0.5 to 1.75, more preferably from 1.25 to 1.75. Especially preferred lithium-manganese cathodic materials of this type include LiₐMn_{(1-1.75)}Ni_{(1-0.25)}O₄.

Other suitable lithium-manganese cathodic materials include layered manganese cathodic materials. These include lithium-manganese oxides that have the empirical formula LiₐMn_{q}M_{(2-a-q)}O₂, wherein q is from 0.4 to 0.8 and M and a are as before. M is preferably Fe, Co, Ni or a mixture of any two or more thereof, and is most preferably Ni. An especially preferred cathodic material of this type has the empirical formula LiₐMn_{(0.4-0.6)}Ni_{(0.01-0.3)}Co_{(0.01-0.2)}O₂, wherein a is from 1.15 to 1.25.

The lithium-manganese cathodic material is in the form of a particulate. Smaller particle sizes are generally preferred, as this increases available surface area and improves performance. The particles of the lithium-manganese cathodic material may have longest dimensions from 2 nm to 20 μm. A preferred particle size for a manganese-containing olivine cathodic material is from 5 nm to 500 nm in the longest dimension, and a more preferred particle size is from 5 nm to 200 nm in the longest dimension. An especially preferred particle size in such a case is from 5 to 100 nm. Manganese-containing spinel cathodic materials and layered manganese-containing cathodic materials may have particle sizes from 2 to 10 μm in their longest dimension.

The lithium-manganese cathodic material particles may be composite particles that contain a carbonaceous material in addition to the lithium-manganese cathodic material. One type of composite particle is an olivine LiₐMnₓM₍₁₋ₓ₎(PO₄)_{b}/C composite, wherein x, M, a and b are as defined before, and the C (carbon) content is from 0.5 to 20% by weight. Such composites are described, for example, in WO 2009/127901 and WO 2009/144600. These composites are conveniently made by milling precursors for the LiₐMnₓM₍₁₋ₓ₎(PO₄)_{b} cathodic material with carbon in the form of, for example, an electro-conductive carbon black having a surface area of at least 80 m²/g, an activated carbon having a specific surface area of at least 200 m²/g or graphite having a surface area of at least 9.5 m²/g, and then if necessary calcining the resulting milled mixture. This method is described in more detail in WO 2009/144600.

Another useful type of lithium-manganese cathodic material is a composite particle having a lithium manganese cathodic material, a carbon layer, and a manganese oxide interface layer interposed between the lithium-manganese cathodic material and the carbon layer. Materials of this type, in which the lithium-manganese cathodic material is an olivine LiₐMnₓM₍₁₋ₓ₎(PO₄)_{b}, are described, for example, in WO 2009/010895.

Any such composite particle preferably contains at least 80%, more preferably at least 90% by weight of the lithium-manganese cathodic material.

Mixtures of any two or more of the foregoing types of lithium-manganese cathodic material particles can be used.

To form the cathode, a mixture of particles of the cathodic material with lithium oxalate particles is formed. The mixture can be formed in any convenient manner. The particles of the cathodic material and those of the lithium oxalate can be formed separately and blended if desired. The cathodic material can be milled together with lithium oxalate if desired to form a mixture of particles. It may also be possible in some instances to form a mixture of lithium oxalate and precursors into a cathode, and then allow the precursors to react in the presence of lithium oxalate to form the particle mixture. It is also possible to form composite particles containing both the lithium oxalate and the cathodic material.

From 0.5 to 20 parts by weight of lithium oxalate are present per 100 parts by weight of the cathodic material. A preferred amount is from 1 to 10 parts, and a more preferred amount is from 3 to 10 parts, per 100 parts by weight of the cathodic material.

The binder is a material that is capable of holding the cathodic material particles together in the presence of the battery electrolyte solution and under the conditions of battery operations. The binder is generally nonconductive or at most slightly conductive. Typical binders include organic polymers that are thermoplastic and/or soluble in an organic solvent. Among the useful polymeric binders are poly(vinylidene fluoride), polytetrafluoroethylene, a styrene-butadiene copolymer, an isoprene rubber, a poly(vinyl acetate), a poly(ethyl or methyl methacrylate), polyethylene, carboxymethylcellulose, nitrocellulose, a 2-ethylhexyl acrylate-acrylonitrile copolymer, and the like. The binder suitably constitutes from 1 to 25%, preferably from 1 to 10% by weight of the cathode.

The cathode may also contain additional ingredients such as, for example, conductive particles and/or fibers such as various conductive carbonaceous materials like carbon particles, carbon nanotubes, carbon nanowires and the like.

A cathode can be assembled from the foregoing ingredients in any convenient manner. Suitable methods for constructing lithium ion battery electrodes include those described, for example, in U.S. Pat. No. 7,169,511.

The diluent is a liquid in which the other materials are dispersible. The diluent is typically a solvent for the binder. In many cases, a binder solution can simply be mixed with the lithium oxalate and particles of the cathodic material, formed into the appropriate shape and then subjected to conditions (generally including an elevated temperature) sufficient to remove the solvent or liquid continuous phase.

The binder/particle mixture may be cast onto or around a support (which may also function as a current collector) or into a form or mold. Suitable current collectors for the cathode include those made of aluminum, titanium, tantalum, alloys of two or more of these and the like.

The binder/particle mixture may be impregnated into or onto various types of mechanical reinforcing structures, such as meshes, fibers, and the like, in order to provide greater mechanical strength to the electrode. Upon removing the solvent or carrier fluid, the particles of cathodic material become bound together by the binder to form a solid cathode that contains the lithium oxalate. The lithium oxalate may be distributed through the cathode in the form of particles, and/or may form composite particles with the cathodic material. The electrode is often significantly porous.

A protective or passivating coating can be applied to the cathode or its constituent cathodic material particles if desired or useful.

The cathode of the invention is useful in lithium batteries. The lithium battery can be of any useful construction. A typical battery construction includes an anode and cathode, with a separator and the electrolyte solution interposed between the anode and cathode so that ions can migrate through the electrolyte solution between the anode and the cathode. The assembly is generally packaged into a case. The shape of the battery is not limited. The battery may be a cylindrical type containing spirally-wound sheet electrodes and separators. The battery may be a cylindrical type having an inside-out structure that includes a combination of pellet electrodes and a separator. The battery may be a plate type containing electrodes and a separator that have been superimposed.

The anode contains an anode material that can reversibly intercalate lithium ions during a battery charging cycle and release lithium ions into a battery electrolyte solution (with production of electrons) during a battery discharge cycle. Suitable anode materials include, for example, carbonaceous materials such as natural or artificial graphite, carbonized pitch, carbon fibers, porous glassy carbon, graphitized mesophase microspheres, furnace black, acetylene black and various other graphitized materials. Other materials such as lithium, silicon, germanium and molybdenum oxide are useful anode materials. An anode can contain two or more of these anode materials. The anode material is typically in the form of particles that are held together by a binder. The anode is typically formed onto or around a support that may function as a current collector. A suitable current collector for the anode is made of a metal or metal alloy such as copper, a copper alloy, nickel, a nickel alloy, stainless steel and the like.

In the lithium battery, the separator is interposed between the anode and cathode to prevent the anode and cathode from coming into contact with each other and short-circuiting. The separator is conveniently constructed from a nonconductive material. It should not be reactive with or soluble in the electrolyte solution or any of the components of the electrolyte solution under operating conditions. Polymeric separators are generally suitable. Examples of suitable polymers for forming the separator include polyethylene, polypropylene, polybutene-1, poly-3-methylpentene, ethylene-propylene copolymers, polytetrafluoroethylene, polystyrene, polymethylmethacrylate, polydimethylsiloxane, polyethersulfones and the like.

The electrolyte solution must be able to permeate through the separator. For this reason, the separator is generally porous, being in the form of a porous sheet, nonwoven or woven fabric or the like. The porosity of the separator is generally 20% or higher, up to as high as 90%. A preferred porosity is from 30 to 75%. The pores are generally no larger than 0.5 microns, and are preferably up to 0.05 microns in their longest dimension. The separator is typically at least one micron thick, and may be up to 50 microns thick. A preferred thickness is from 5 to 30 microns.

The battery contains an electrolyte that is in contact with both the anode and cathode. The basic components of the battery electrolyte solution are a lithium salt and a nonaqueous solvent for the lithium salt.

The lithium salt may be any that is suitable for battery use, including inorganic lithium salts such as LiAsF₆, LiPF₆, LiBF₄, LiClO₄, LiBrO₄ and LiIO₄ and organic lithium salts such as LiB(C₂O₄)₂, LiBF₂C₂O₄, LiB(C₆H₅)₄, LiCH₃SO₃, LiN(SO₂C₂F₅)₂ and LiCF₃SO₃. LiPF₆, LiClO₄, LiBF₄, LiAsF₆, LiCF₃SO₃ and LiN(SO₂CF₃)₂ are preferred types. The benefits of the invention are especially seen when LiPF₆ is present as the sole lithium salt, or the lithium salt present in the greatest molar amount.

The lithium salt is suitably present in a concentration of at least 0.5 moles/liter of electrolyte solution, preferably at least 0.75 moles/liter, up to 3 moles/liter and more preferably up to 1.5 moles/liter.

The nonaqueous solvent may include, for example, one or more linear alkyl carbonates, cyclic carbonates, cyclic esters, linear esters, cyclic ethers, alkyl ethers, nitriles, sulfones, sulfolanes, siloxanes and sultones. Mixtures of any two or more of the foregoing types can be used. Cyclic esters, linear alkyl carbonates, and cyclic carbonates are preferred types of nonaqueous solvents. An advantage of this invention is that good performance is achieved even when the solvent contains at least 80%, at least 90% or even at least 95% by weight of cyclic and/or linear carbonate solvents.

Suitable linear alkyl carbonates include dimethyl carbonate, diethyl carbonate, methyl ethyl carbonate and the like. Cyclic carbonates that are suitable include ethylene carbonate, propylene carbonate, butylene carbonate and the like. Suitable cyclic esters include, for example, γ-butyrolactone and γ-valerolactone. Cyclic ethers include tetrahydrofuran, 2-methyltetrahydrofuran, tetrahydropyran and the like. Alkyl ethers include dimethoxyethane, diethoxyethane and the like. Nitriles include mononitriles, such as acetonitrile and propionitrile, dinitriles such as glutaronitrile, and their derivatives. Sulfones include symmetric sulfones such as dimethyl sulfone, diethyl sulfone and the like, asymmetric sulfones such as ethyl methyl sulfone, propyl methyl sulfone and the like, and their derivatives. Sulfolanes include tetramethylene sulfolane and the like.

Some preferred solvent mixtures include mixtures of a cyclic carbonate with one or more linear alkyl carbonates at a weight ratio of from 15:85 to 40:60; a cyclic carbonate/cyclic ester mixture at a weight ratio of from 20:80 to 60:40: a cyclic carbonate/cyclic ester/linear alkyl carbonate mixture at weight ratios of 20-48:50-78:2-20; cyclic ester/linear alkyl carbonate mixtures at a weight ratio of from 70:30 to 98:2.

Solvent mixtures of particular interest are mixtures of ethylene carbonate and propylene carbonate at a weight ratio of from 15:85 to 40:60; mixtures of ethylene carbonate with dimethyl carbonate and/or ethylmethyl carbonate at a weight ratio of from 15:85 to 40:60; mixtures of ethylene carbonate, propylene carbonate with dimethyl carbonate and/or ethylmethyl carbonate at a weight ratio of 20-48:50-78:2-20, and mixtures of propylene carbonate with dimethyl carbonate and/or ethylmethyl carbonate at a weight ratio of from 15:85 to 40:60.

Various other additives may be present in the battery electrolyte solution. These may include, for example, additives which promote the formation of a solid electrolyte interface at the surface of a graphite electrode; various cathode protection agents; lithium salt stabilizers; lithium deposition improving agents; ionic solvation enhancers; corrosion inhibitors; wetting agents; flame retardants; and viscosity reducing agents. Many additives of these types are described by Zhang in “A review on electrolyte additives for lithium-ion batteries”, J. Power Sources 162 (2006) 1379-1394.

Agents which promote solid electrolyte interface (SEI) formation include various polymerizable ethylenically unsaturated compounds, various sulfur compounds, as well as other materials. Suitable cathode protection agents include materials such as N,N-diethylaminotrimethylsilane and LiB(C₂O₄)₂. Lithium salt stabilizers include LiF, tris(2,2,2-trifluoroethyl)phosphite, various amides, 1-methyl-2-pyrrolidinone, fluorinated carbamate, bis(trimethylsilyl)urea, hexamethylphosphoramide, various compounds containing Si—H bonds and various Si—N compounds such as hexamethylcyclotrisilazane, octamethylcyclotetrasilazane, tetra(ethenyl)-tetramethyl-tetrazatetrasilocane, hexamethyldisilazane, lithium hexamethyldisilazane, heptamethyldisilazane and tetramethyldisilazane. Examples of lithium deposition improving agents include sulfur dioxide, polysulfides, carbon dioxide, surfactants such as tetraalkylammonium chlorides, lithium and tetraethylammonium salts of perfluorooctanesulfonate, various perfluoropolyethers and the like. Crown ethers can be suitable ionic solvation enhancers, as are various borate, boron and borole compounds. LiB(C₂O₄)₂ and LiF₂C₂O₄ are examples of aluminum corrosion inhibitors. Cyclohexane, trialkyl phosphates and certain carboxylic acid esters are useful as wetting agents and viscosity reducers. Some materials, such as LiB(C₂O₄)₂, may perform multiple functions in the electrolyte solution.

The various other additives may together constitute up to 20%, preferably up to 10% of the total weight of the battery electrolyte solution. The water content of the resulting battery electrolyte solution should be as low as possible. A water content of 50 ppm or less is desired and a more preferred water content is 30 ppm or less.

The battery is preferably a secondary (rechargeable) lithium battery. In such a battery, the discharge reaction includes a dissolution or delithiation of lithium ions from the anode into the electrolyte solution and concurrent incorporation of lithium ions into the cathode. The charging reaction, conversely, includes an incorporation of lithium ions into the anode from the electrolyte solution; at the same time, lithium ions in the cathodic material dissolve into the electrolyte solution.

The battery of the invention can be used in industrial applications such as electric vehicles, hybrid electric vehicles, plug-in hybrid electric vehicles, aerospace, e-bikes, etc. The battery of the invention is also useful for operating a large number of electrical and electronic devices, such as computers, cameras, video cameras, cell phones, PDAs, MP3 and other music players, televisions, toys, video game players, household appliances, power tools, medical devices such as pacemakers and defibrillators, among many others.

Lithium batteries containing a cathode in accordance with the invention often exhibit surprisingly high initial specific capacities and excellent capacity retention upon charge/discharge cycling. Initial specific charge and discharge capacities can be 5% -20% or more greater than that of a similar battery without lithium oxalate present in the cathode. In particular the battery exhibits surprisingly high specific capacity retention when cycled at C rates of at least 1C, such as from 1C to 5C, and when cycled at elevated temperatures such as from 40 to 50° C.

Cycling stability can be evaluated by running the battery through a fixed number of charge/discharge cycles, at a given C-rate, and measuring the capacity of the battery at the start and at the end of the evaluation. Useful test regimens for measuring specific capacity and capacity retention during cycling include the high voltage cycling test, the full range cycling test and the 50° C. cycling test described in Example 1. On each of these tests, capacity tends to fall as the battery continues to be charged and discharged. Batteries of this invention often retain 85% or more of their initial specific capacities after 50 1C charge/discharge cycles on the high voltage cycling test described in Example 1, and after 150 charge/discharge cycles on the 50° C. cycling test described in Example 1.

The following examples are intended to illustrate the invention, but not to limit the scope thereof. All parts and percentages are by weight unless otherwise indicated.

### EXAMPLE 1 AND COMPARATIVE SAMPLES A AND B

MnCO₃, LiH₂PO₄ (2.5% excess), FeC₂O₄.2H₂O and pure carbon black powder are ball milled together for several hours, and the resulting milled mixture is calcined at 530° C. for three hours under argon to produce LiMn_{0.76}Fe_{0.24}PO₄/C composite particles that contain 8% by weight carbon.

To produce Comparative Cathode A, 4.65 g of these particles are mixed with 0.1 g of vapor-grown carbon fibers and 5 g of a 5 wt. % polyvinylidenedifluoride solution in N-methylpyrrolidinone (NMP), with additional NMP as needed to provide a workable slurry viscosity. The slurry is coated onto a carbon-coated aluminum foil and most of the solvent is removed under vacuum. The electrode is then dried at 80° C. overnight, pressed at 142 MPa, and dried again at 150° C. under vacuum.

Electrode Example 1 is made in the same manner, except 0.2 g of lithium oxalate is ground with the LiMn_{0.76}Fe_{0.24}PO₄/C composite particles prior to forming the electrode. The resulting electrode contains approximately 3.8 weight percent lithium oxalate.

CR2032 coin cells (Comparative Cells A and B and Cell Example 1) are assembled using Comparative Cathode A (Comp. Cells A and B) and Cathode Example 1 (Cell Example 1). The anode in each case is a flake graphite electrode. The electrolyte in Cell Example 1 and Comparative Cell A is a 1 M solution of LiPF₆ in a 1:1:1 by weight mixture of ethylene carbonate, dimethyl carbonate and ethylmethylcarbonate that contains 2% of vinylidene carbonate. The electrolyte in Comparative Cell B also contains 1% by weight lithium oxalate. The separator in each case is a commercially available 21.5 μm thick porous polypropylene/polyethylene/polypropylene trilayer material (Celgard C480, from Celgard LLC, Charlotte, N.C., US). Each of Comparative Cell A and Cell Example 1 are tested in triplicate in each of the following test protocols.

Comparative Cells A and B and Cell Example 1 are subjected to high-voltage cycling testing at room temperature (25±5° C.) according to the following protocol: (1) SEI formation (2 cycles): charge at constant current (CC) to 4.85 V at a C-rate of C/10; then at constant voltage (CV) to C/100; discharge at CC to 3.0 V at C/10; then (2) Cycling: charge at CC to 4.85 V at 1C, then at CV to C/100; discharge at CC to 3 V at 1C, repeated for 50 cycles.

The specific charge capacity and specific discharge capacity is measured for each of Comparative Cells A and B and Cell Example 1 at the first and the 50^{th} cycle. Results are as shown in Table 1:

TABLE 1
High Voltage Cycling

| | | | | | 50^{th} | |
|---|---|---|---|---|---|---|
| | | | 1^{st} Cycle | 1^{st} Cycle | Cycle | 50^{th} Cycle |
| | | | Charge | Discharge | Charge | Discharge |
| Sample | | | Capacity | Capacity | Capacity | Capacity |
| Designation | Cathode | Electrolyte | (mAh/g) | (mAh/g) | (mAh/g) | (mAh/g) |
| A* | LMFP | EC:DMC 1:1 + | 152 | 119 | 89 | 89 |
| | | 1M LiPF₆ + 2 wt. | | | | |
| | | % VC | | | | |
| B* | LMFP | EC:DMC 1:1 + | 153 | 125 | 90 | 89 |
| | | 1M LiPF₆ + 2 wt. | | | | |
| | | % VC + 1 wt. | | | | |
| | | % LiOX | | | | |
| 1 | LMFP + | EC:DMC 1:1 + | 167 | 138 | 104 | 103 |
| | 4 wt. % | 1M LiPF₆ + 2 wt. | | | | |
| | LiOX | % VC | | | | |

*Not an example of the invention. LMFP is lithium manganese iron phosphate. VC is vinylidene carbonate. LiOX is lithium oxalate.

As can be seen from the data in Table 1, the inclusion of lithium oxalate in the electrolyte solution has little effect on battery capacity, either initially or after 50 cycles. The cell of the invention, however, shows increases of greater than 10% in battery capacity both initially and after 50 cycles.

Comparative Cell A and Cell Example 1 are subjected to full-range C-rate testing at room temperature (25±5° C.) according to the following protocol:

(1) SEI formation (2 cycles): charge at constant current (CC) to 4.2 V at a C-rate of C/10; then at constant voltage (CV) to C/100; discharge at CC to 2.7 V at C/10; then
(2) C-rate testing: (5 cycles):

(a) charge at CC to 4.2 V at C/5, then at CV to C/100; discharge at CC to 2.7 V at C/5;

(b) charge at CC to 4.2 V at C/2, then at CV to C/100; discharge at CC to 2.7 V at C/2;

(c) charge at CC to 4.2 V at 1C, then at CV to C/100; discharge at CC to 2.7 V at 1C;

(d) charge at CC to 4.2 V at 2C, then at CV to C/100; discharge at CC to 2.7 V at 2C;

(e) charge at CC to 4.2 V at 5C, then at CV to C/100; discharge at CC to 2.7 V at 5C; then

(3) Cycling: charge at CC to 4.2 V at 1C, then at CV to C/100; discharge at CC to 2.7 V at 1C, repeated for 100 cycles.

The specific capacities of each of Comparative Cell A and Cell Example 1 (average of three triplicate cells in each case) are as shown in Table 2:

TABLE 2
Full Range Discharge Testing

| | Specific Capacity, mAh/g | | | | |
|---|---|---|---|---|---|
| C-rate | C/5 | C/2 | C | 2 C | 5 C |
| Comparative Cell A | 116 | 112 | 106 | 96 | 62 |
| Example 1 | 126 | 120 | 112 | 103 | 79 |
| % Increase, Example 1 vs. | 9 | 7 | 6 | 7 | 27 |
| Comp. Cell A | | | | | |

Cell Example 1 retains 86% of its initial capacity after 100 cycles at 1C, whereas Comparative Cell A retains less than 80% of its initial capacity. Comparative Cell A exhibits a rapid loss of capacity over the first 5-20 cycles, which is not seen with Cell Example 1.

Cell Example 1 and Comparative Cell A are each evaluated at 50° C. using the following protocol:

(1) SEI formation (2 cycles): charge at constant current (CC) to 4.2 V at a C-rate of C/10; then at constant voltage (CV) to C/100; discharge at CC to 2.7 V at C/10; then
(2) Cycling: charge at CC to 4.2 V at 1C, then at CV to C/100; discharge at CC to 2.7 V at 1C, repeated for 150 cycles.

Cell Example 1 retains about 85% of its initial capacity on this test, whereas Comparative Cell A retains only about 78% of its initial capacity. Initial capacities in each case are about 122 mAH/g.

These results demonstrate a significant improvement in capacity retention through the incorporation of lithium oxalate into a lithium-manganese cathode.

### EXAMPLES 2-3 AND COMPARATIVE SAMPLES C AND D

CR2032 coin cells (Comparative Cells C and D and Cell Examples 2 and 3) are assembled using Comparative Cathode A (Comp. Cells C and D) and Cathode Example 1 (Cell Examples 2 and 3). The anode in each case is a flake graphite electrode. The electrolyte in Cell Example 2 and Comparative Cell C is a 1 M solution of LiPF6 in a 1:1 by weight mixture of ethylene carbonate and dimethyl carbonate that contains 2% of vinylidene carbonate. The electrolytes in Comparative Cell D and Cell Example 3 also contain 1% by weight hexamethyldisilazane. The separator in each case is a commercially available 21.5 μm porous polypropylene/polyethylene/polypropylene trilayer material (Celgard C480, from Celgard LLC, Charlotte, N.C., US).

Comparative Cells A and B and Cell Example 1 are subjected to full-range C-rate testing at room temperature (25±5° C.), following the protocol described in Example 1 except that the cycling at 1C is carried out for 120 cycles. Specific capacity in each case is measured for each of the five C-rates during the C-rate cycling portion of the test, and during the first, 10^{th}, 20^{th}, 40^{th}, 60^{th} and 120^{th} cycle during the 1C cycling portion of the test. Results are as indicated in Table 3.

TABLE 3

| | Comp. | Comp. | | |
|---|---|---|---|---|
| | Sample C* | Sample D* | Example 3 | Example 4 |
| Cathode | LMFP | LMFP | LMPF + | LMFP + |
| | | | 4% LiOX | 4% LiOX |
| Electrolyte | No | contains | No | contains |
| | hexa- | hexa- | hexa- | hexa- |
| | methyl- | methyl- | methyl- | methyl- |
| | Disilazane | disilazane | disilazane | disilazane |
| | Specific Capacity (mAh/g) | | | |
| C/5 | 116 | 119 | 126 | 125 |
| C/2 | 112 | 112 | 120 | 119 |
| 1 C | 106 | 105 | 112 | 111 |
| 2 C | 96 | 92 | 103 | 104 |
| 5 C | 62 | 58 | 79 | 77 |
| 1^{st} cycle | 105 | 102 | 109 | 109 |
| 10^{th} cycle | 98 | 97 | 106 | 105 |
| Capacity retention | 93% | 94% | 98% | 96% |
| after 10^{th} cycle | | | | |
| 20^{th} cycle | 93 | 93 | 103 | 101 |
| Capacity retention | 89% | 91% | 95% | 92% |
| after 20^{th} cycle | | | | |
| 40^{th} cycle | 90 | 92 | 99 | 96 |
| Capacity retention | 86% | 89% | 91% | 87% |
| after 40^{th} cycle | | | | |
| 60^{th} cycle | 88 | 91 | 97 | 94 |
| Capacity retention | 83% | 89% | 89% | 86% |
| after 60^{th} cycle | | | | |
| 120^{th} cycle | 82 | 90 | 94 | 98 |
| Capacity retention | 78% | 88% | 87% | 90% |
| after 120^{th} cycle | | | | |

*Not an example of the invention. LMFP is lithium manganese iron phosphate. LiOX is lithium oxalate.

As can be seen from the data in Table 3, absolute capacities and capacity retentions are significantly greater with the examples of this invention.

### EXAMPLES 5-6 AND COMPARATIVE SAMPLE E

LiNi_{0.5}Mn_{1.15}O₄ (4.5 g), graphite (0.25 g) and 5 g of a 5 wt. % solution of polyvinylidenedifluoride in N-methylpyrrolidinone (NMP), are mixed to form a slurry, with additional NMP as needed to provide a workable slurry viscosity. The slurry is coated onto a carbon-coated aluminum foil and most of the solvent is removed under vacuum. The electrode (Comparative Electrode E) is then dried at 80° C. overnight, pressed at 152 MPa, and dried again at 150° C. under vacuum.

Cathode Example 5 is made in the same manner, except 0.27 g of the LiNi_{0.5}Mn_{1.5}O₄ is replaced with an equal weight of lithium oxalate, which is ground with the LiNi_{0.5}Mn_{1.5}O₄ particles prior to forming the electrode. The resulting electrode contains approximately 4 weight percent lithium oxalate.

Cathode Example 5 is made in the same manner, except 0.4 g of the LiNi_{0.5}Mn_{1.5}O₄ is replaced with an equal weight of lithium oxalate, which is ground with the LiNi_{0.5}Mn_{1.5}O₄ particles prior to forming the electrode. The resulting electrode contains approximately 6 weight percent lithium oxalate.

CR2032 coin cells (Comparative Cells E and Cell Examples 5 and 6) are assembled using Comparative Cathode E (Comp. Cells E) and Cathode Examples 5 and 6 (Cell Examples 5 and 6, respectively). The anode in each case is a flake graphite electrode. The electrolyte in Cell Examples 5 and 6 and Comparative Cell E is in each case a 1 M solution of LiPF6 in a 1:1:1 by weight mixture of ethylene carbonate, dimethyl carbonate and ethylmethyl carbonate. The separator in each case is a commercially available 21.5 μm thick porous polypropylene/polyethylene/polypropylene trilayer material (Celgard C480, from Celgard LLC, Charlotte, N.C., US). Each of Comparative Cell E and Cell Examples 5 and 6 are tested in triplicate in each of the following test protocols.

Comparative Cell E and Cell Examples 5 and 6 are subjected to high-voltage cycling testing at room temperature (25±5° C.) according to the corresponding protocol described in Example 1, except cycling is continued through 100 cycles. The specific charge capacity and specific discharge capacity is measured for each of Comparative Cell E and Cell Examples 5 and 6 at the first, second and the 100^{th} cycle. Results are as shown in Table 4:

TABLE 4
High Voltage Cycling

| | | | | 2nd | | 100^{th} | 100^{th} |
|---|---|---|---|---|---|---|---|
| | | 1^{st} Cycle | 1^{st} Cycle | Cycle | 2nd Cycle | Cycle | Cycle |
| | | Charge | Discharge | Charge | Discharge | Charge | Discharge |
| Sample | | Capacity | Capacity | Capacity | Capacity | Capacity | Capacity |
| Designation | Cathode | (mAh/g) | (mAh/g) | (mAh/g) | (mAh/g) | (mAh/g) | (mAh/g) |
| E* | LNMO | 111 | 71 | 116 | 110 | 97 | 97 |
| 5 | LNMO + | 117 | 71 | 123 | 116 | 104 | 103 |
| | 4 wt % | | | | | | |
| | LiOX | | | | | | |
| 6 | LNMO + | 120 | 71 | 125 | 118 | 108 | 108 |
| | 6 wt % | | | | | | |
| | LiOX | | | | | | |

*Not an example of the invention. LMNO is lithium manganese nickel oxide. LiOX is lithium oxalate.

As shown in Table 4, the addition of lithium oxalate into the LMNO electrode leads to significant increases in capacity.

1-3. (canceled)

4. The lithium battery of claim 16 wherein the lithium-manganese cathodic material is one or more of a lithium-manganese oxide, a lithium-manganese phosphate, a lithium-manganese silicate, a lithium-manganese sulfate, a lithium-manganese borate, and a lithium-manganese vanadate, which may contain Fe, Co, Ni, Cr, V, Mg, Ca, Al, B, Zn, Cu, Nb, Ti, Zr, La, Ce, Y or a mixture of any two or more thereof.

5. The lithium battery of claim 4 wherein the lithium-manganese cathodic material is a lithium-manganese phosphate having the empirical formula LiₐMnₓM₍₁₋ₓ₎(PO₄)_{b}, wherein x is from 0.1 to 1.0, M is Fe, Co, Ni, Cr, V, Mg, Ca, Al, B, Zn, Cu, Nb, Ti, Zr, La, Ce, Y or a mixture of any two or more thereof, a is from 0.8 to 1.1 and b is from 0.9 to 1.1.

6. The lithium battery of claim 5 wherein M is Fe, Co, Ni or a mixture of any two or more thereof and x is from 0.3 to 1.0.

7. The lithium battery of claim 6 wherein the cathodic material has the empirical formula LiₐMn_{0.25-0.9}Fe_{(0.75-0.1)}(PO₄)_{b}, wherein a is from 0.8 to 1.1 and b is from 0.9 to 1.1.

8. (canceled)

9. The lithium battery of claim 16 wherein the lithium-manganese cathodic material is a lithium-manganese oxide having the empirical formula LiₐMn_{z}M_{(2-z)}O₄, wherein z is from 0.25 to 2.0, M is Fe, Co, Ni, Cr, V, Mg, Ca, Al, B, Zn, Cu, Nb, Ti, Zr, La, Ce, Y or a mixture of any two or more thereof, and a is from 0.8 to 1.1.

10. The lithium battery of claim 16 wherein the lithium-manganese cathodic material has the empirical formula LiₐMn_{(1-1.75)}Ni_{(1-0.25)}O₄, wherein a is from 0.8 to 1.1.

11. (canceled)

12. The lithium battery of claim 16 wherein the lithium-manganese cathodic material is a lithium-manganese oxide having the empirical formula LiₐMn_{q}M_{(2-a-q)}O₂, wherein q is from 0.4 to 0.8, M is Fe, Co, Ni, Mo, W, Cr, V, Mg, Ca, Al, B, Zn, Cu, Nb, Ti, Zr, La, Ce, Y or a mixture of any two or more thereof, and a is from 1.1 to 1.3.

13. (canceled)

14. The lithium battery of claim 16 wherein the lithium-manganese cathodic material has the empirical formula LiₐMn_{(0.4-0.6)}Ni_{(0.01-0.3)}Co_{(0.01-0.2)}O₂, wherein a is from 1.15 to 1.25.

15. (canceled)

16. A lithium battery comprising a cathode, an anode, a separator disposed between the anode and cathode, and an electrolyte solution in contact with the anode and cathode, wherein the cathode comprises particles of at least one lithium-manganese cathodic material bound together by a binder and further contains from 0.5 to 20 parts by weight of lithium oxalate per 100 parts by weight of the particles of lithium-manganese cathodic material, the electrolyte solution contains LiPF₆ and at least 90% by weight of the solvent in the electrolyte solution is one or more cyclic and/or linear carbonate solvents.

17-18. (canceled)

19. The lithium battery of claim 16, wherein the solvent in the electrolyte solution is a mixture of ethylene carbonate and at least one of dimethyl carbonate and ethylmethyl carbonate.

20. The lithium battery of claim 16, wherein the electrolyte solution contains one or more of hexamethylcyclotrisilazane, octamethylcyclotetrasilazane, tetra(ethenyl)-tetramethyl-tetrazatetrasilocane, hexamethyldisilazane, lithium hexamethyldisilazane, heptamethyldisilazane and tetramethyldisilazane.

21-25. (canceled)
